(19) United States
(12) Patent Application Publication
(10) Pub. No.: US 2024/0304196 A1
(43) Pub. Date: Sep. 12, 2024

(54) MULTI-BAND DUCKING OF AUDIO SIGNALS

(71) Applicants: Dolby Laboratories Licensing Corporation, San Francisco, CA (US); DOLBY INTERNATIONAL AB, Dublin (IE)

(72) Inventors: Rishabh TYAGI, Sydney, NSW (AU); Heiko PURNHAGEN, Sundbyberg (SE)

(73) Assignees: Dolby Laboratories Licensing Corporation, San Francisco, CA (US); DOLBY INTERNATIONAL AB, Dublin (IE)

(21) Appl. No.: 18/551,134

(22) PCT Filed: Apr. 1, 2022
(86) PCT No.: PCT/US2022/023057

§ 371 Date: Sep. 18, 2023

Related U.S. Application Data
(60) Provisional application No. 63/171,219, filed on Apr. 6, 2021.
(60) Provisional application No. 63/268,991, filed on Mar. 8, 2022.

(51) Int. Cl. G10L 19/02; G10L 19/008

(52) U.S. Cl. CPC G10L 19/0204; G10L 19/008

(57) ABSTRACT

A method for multi-band ducking of audio signals is provided. In some implementations, the method involves receiving, at a decoder, an input audio signal, wherein the input audio signal is a downmixed audio signal. In some implementations, the method involves separating the input audio signal into a first set of frequency bands. In some implementations, the method involves determining a set of ducking gains, a ducking gain corresponding to a frequency band of the first set of frequency bands. In some implementations, the method involves generating a broadband decorrelated audio signal, wherein ducking gains of the set of ducking gains are applied to at least one of: 1) a second set of frequency bands prior to generating the at least one broadband decorrelated audio signal: or 2) a third set of frequency bands that separates the at least one broadband decorrelated audio signal.

### CROSS REFERENCE TO RELATED APPLICATIONS

This application claims priority to U.S. provisional applications Ser. No. 63/268,991, filed 8 Mar. 2022 and 63/171,219, filed 6 Apr. 2021, all of which are incorporated herein by reference in their entirety.

This disclosure pertains to systems, methods, and media for multi-band ducking of audio signals.

### BACKGROUND

Ducking of audio signals may be performed, for example, to attenuate various types of signals, such as transients. However, ducking of audio signals, as conventionally performed, may result in various artifacts, such as a ringing artifact, undesired artifacts when rendering spatial scenes, etc.

### NOTATION AND NOMENCLATURE

Throughout this disclosure, including in the claims, the terms “speaker,” “loudspeaker” and “audio reproduction transducer” are used synonymously to denote any sound-emitting transducer or set of transducers. A typical set of headphones includes two speakers. A speaker may be implemented to include multiple transducers, such as a woofer and a tweeter, which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data, such as filtering, scaling, transforming, or applying gain to, the signal or data, is used in a broad sense to denote performing the operation directly on the signal or data, or on a processed version of the signal or data. For example, the operation may be performed on a version of the signal that has undergone preliminary filtering or pre-processing prior to performance of the operation thereon.

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable, such as with software or firmware, to perform operations on data, which may include audio, or video or other image data. Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

At least some aspects of the present disclosure may be implemented via methods. Some methods may involve receiving, at a decoder, an input audio signal, wherein the input audio signal is a downmixed audio signal. Some methods may involve separating the input audio signal into a first set of frequency bands. Some methods may involve determining a set of ducking gains, a ducking gain of the set of ducking gains corresponding to a frequency band of the first set of frequency bands. Some methods may involve generating at least one broadband decorrelated audio signal, wherein the at least one broadband decorrelated audio signal is usable to upmix the downmixed audio signal, and wherein ducking gains of the set of ducking gains are applied to at least one of: 1) a second set of frequency bands prior to generating the at least one broadband decorrelated audio signal; or 2) a third set of frequency bands that separates the at least one broadband decorrelated audio signal.

In some examples, the set of ducking gains comprises a set of input ducking gains, and further comprising applying input ducking gains of the set of input ducking gains to the second set of frequency bands prior to generating the at least one broadband decorrelated audio signal. In some examples, ducked signals associated with frequency bands of the second set of frequency bands are aggregated to generate a broadband ducked signal that is provided to a decorrelator configured to generate the at least one broadband decorrelated audio signal.

In some examples, the first set of frequency bands and the second set of frequency bands are two instances of the same set of frequency bands.

In some examples, the set of ducking gains comprises a set of output ducking gains, an some methods may further involve: applying output ducking gains of the set of output ducking gains to the third set of frequency bands to generate at least one set of ducked decorrelated audio signals, each ducked decorrelated audio signal in the at least one set of ducked decorrelated audio signals corresponding to a frequency band of the third set of frequency bands; and aggregating ducked decorrelated audio signals in the at least one set of ducked decorrelated audio signals to generate at least one broadband ducked decorrelated audio signal, the at least one broadband ducked decorrelated audio signal being usable to upmix the downmixed audio signal.

In some examples, determining the set of ducking gains comprises: determining one or more initial ducking gains; and modifying at least one of the one or more initial ducking gains to generate the set of ducking gains, wherein the at least one of the one or more initial ducking gains are modified by performing update and/or release control.

In some examples, for a frequency band of the first set of frequency bands, a corresponding ducking gain is determined based on a ratio comprising outputs of two envelope trackers, the two envelope trackers corresponding to a slow envelope tracker and a fast envelope tracker. In some examples, the slow envelope tracker comprises an absolute value computation block and a first low pass filter, and wherein the fast envelope tracker comprises the absolute value computation block and a second low pass filter, the first low pass filter and the second low pass filter having different time constants. In some examples, some methods may further involve applying a high-pass filter to at least one frequency band of the first set of frequency bands, wherein an output of the high-pass filter is provided to at least one of the two envelope trackers. In some examples, the high-pass filter is applied to two or more frequency bands of the first set of frequency bands, and wherein the high-pass filter applied to a first of the two or more frequency bands has a different cut-off frequency than the high-pass filter applied to a second of the two or more frequency bands. In some examples, a first low-pass filter of the slow envelope tracker has a time constant longer than a time constant of a second low-pass filter of the fast envelope tracker, and wherein the ratio comprises an output of the slow envelope tracker to an output of the fast envelope tracker. In some examples, a first low-pass filter of the slow envelope tracker has a time constant longer than a time constant of a second low-pass filter of the fast envelope tracker, and wherein the ratio comprises an output of the fast envelope tracker to the slow envelope tracker. In some examples, the ratio comprises a constant specific to the frequency band of the first set of frequency bands, the constant selected to control at least one of: 1) an amount of ducking gain applied to each frequency band of the second set of frequency bands; or 2) an amount of ducking gain applied to each frequency band of the third set of frequency bands.

In some examples, separating the input audio signal into the first set of frequency bands comprises providing the input audio signal to a filterbank. In some examples, the filterbank is implemented as an infinite impulse response (IIR) filterbank or a finite impulse response (FIR) filterbank.

In some examples, the first set of frequency bands, the second set of frequency bands, and/or the third set of frequency bands comprise three frequency bands.

In some examples, the first set of frequency bands is the same as the third set of frequency bands.

In some examples, the at least one broadband decorrelated signal comprises two or more broadband decorrelated signals.

In some examples, some methods further involve upmixing the downmixed audio signal using the at least one broadband decorrelated signal and metadata received at the decoder to generate a reconstructed audio signal. In some examples, some methods further involve rendering the reconstructed audio signal to generate a rendered audio signal. In some example, some methods further involve presenting the rendered audio signal using one or more of: a loudspeaker or headphones.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram of an example multi-channel codec in accordance with some embodiments.

FIG. 2 is a block diagram of a portion of a decoder that includes an instance of a decorrelator with duckers for implementing multi-band ducking in accordance with some embodiments.

FIG. 3 is a block diagram of an instance of a ducker that may be used for implementing multi-band ducking in accordance with some embodiments.

FIG. 4 is a plot of frequency responses of an example filterbank that may be used to implement multi-band ducking in accordance with some embodiments.

FIG. 5 is a flowchart of an example process that may be performed by a decoder for performing multi-band ducking in accordance with some embodiments.

FIG. 6 illustrates example use cases for an Immersive Voice and Audio Services (IVAS) system in accordance with some embodiments.

FIG. 7 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Decorrelators are often used in decoder devices that utilize multi-channel audio codecs, such as stereo audio codecs, parametric stereo, AC-4, or the like. In particular, an N channel input may be downmixed into M channels, where N>M, at an encoder. The M downmixed channels and side information are encoded into a bitstream and transmitted to a decoder. The decoder may then decode the M channels and the side information, and utilize the side information to upmix, or reconstruct, the N channels. In particular, a decorrelator of the decoder device may generate N-M decorrelated signals. The decoder may then utilize the M downmixed channels, the N-M decorrelated signals, and the side information to obtain an approximate reconstruction of the original N channels. In other words, by generating an approximate reconstruction of the original N channels, the decoder may reconstruct the original spatial audio scene.

By way of example, in the case of stereo audio where N corresponds to two channels, and in which M corresponds to one downmixed channel, the decorrelator may generate one decorrelated signal. The decoder may then use the one decorrelated signal, the one downmixed channel, and side information to reconstruct a representation of the original two audio signals. As another example, in the case where N is four channels, such as the channels W, X, Y, Z of a First Order Ambisonics (FOA) signal, and in which M is one downmixed channel, the decorrelator may generate three decorrelated signals. The decoder may utilize these three decorrelated signals to reconstruct the original spatial audio scene.

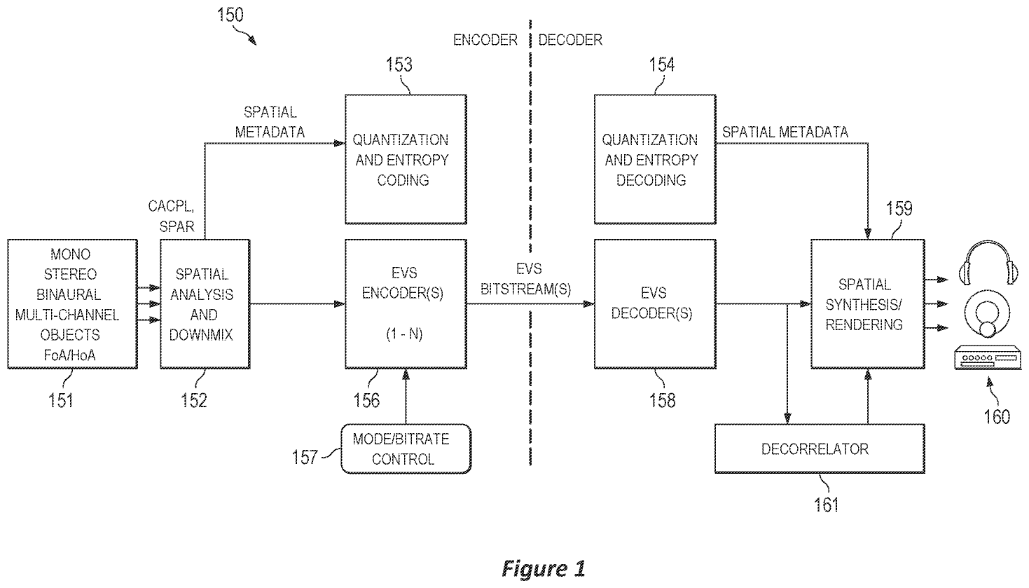

In general, decorrelators may be used to transform an input audio signal into one or more uncorrelated output signals, which may allow for a controllable sense of width, space, or diffuseness, while other perceptual attributes remain unchanged. Accordingly, decorrelators may be useful for reconstructing audio signals with a spatial component. FIG. 1 illustrates a particular example of a codec that utilizes a decorrelator in the decoder to reconstruct an encoded audio signal.

FIG. 1 is a block diagram of an immersive voice and audio services (IVAS) codec 150 for encoding and decoding IVAS bitstreams, according to an embodiment. IVAS codec 150 includes an encoder and far end decoder. The IVAS encoder includes spatial analysis and downmix unit 152, quantization and entropy coding unit 153, core encoding unit 156 and mode/bitrate control unit 157. The IVAS decoder includes quantization and entropy decoding unit 154, core decoding unit 158, spatial synthesis/rendering unit 159 and decorrelator unit 161.

Spatial analysis and downmix unit 152 receives N-channel input audio signal 151 representing an audio scene. Input audio signal 151 includes but is not limited to: mono signals, stereo signals, binaural signals, spatial audio signals, e.g., multi-channel spatial audio objects, FOA, higher order Ambisonics (HOA) and any other audio data. The N-channel input audio signal 151 is downmixed to a specified number of downmix channels (M) by spatial analysis and downmix unit 152. In this example, M is <=N. Spatial analysis and downmix unit 152 also generates side information (e.g., spatial metadata) that can be used by a far end IVAS decoder to synthesize the N-channel input audio signal 151 from the M downmix channels, spatial metadata and decorrelation signals generated at the decoder. In some embodiments, spatial analysis and downmix unit 152 implements complex advanced coupling (CACPL) for analyzing/downmixing stereo/FOA audio signals and/or spatial reconstructor (SPAR) for analyzing/downmixing FOA audio signals. In other embodiments, spatial analysis and downmix unit 152 implements other formats.

The M channels are coded by one or more instances of core codecs included in core encoding unit 156. The side information, e.g., spatial metadata (MD) is quantized and coded by quantization and entropy coding unit 153. The coded bits are then packed together into an IVAS bitstream(s) and sent to the IVAS decoder. In an embodiment, the underlying core codec can be any suitable mono, stereo or multi-channel codec that can be used to generate encoded bitstreams.

In some embodiments, the core codec is an EVS codec. EVS encoding unit 156 complies with 3GPP TS 26.445 and provides a wide range of functionalities, such as enhanced quality and coding efficiency for narrowband (EVS-NB) and wideband (EVS-WB) speech services, enhanced quality using super-wideband (EVS-SWB) speech, enhanced quality for mixed content and music in conversational applications, robustness to packet loss and delay jitter and backward compatibility to the AMR-WB codec.

At the decoder, the M channels are decoded by corresponding one or more instances of core codecs included in core decoding unit 158 and the side information is decoded by quantization and entropy decoding unit 154. A primary downmix channel, such as the W channel in an FOA signal format, is fed to decorrelator unit 161 which generates N-M decorrelated channels. The M downmix channels, N-M decorrelated channels, and the side information are fed to spatial synthesis/rendering unit 159 which uses these inputs to synthesize or regenerate the original N-channel input audio signal, which may be presented by audio devices 160. In an embodiment, M channels are decoded by mono codecs other than EVS. In other embodiments, M channels are decoded by a combination of one or more multi-channel core coding units and one or more single channel core coding units.

An example implementation of coding of an FOA input audio signal with one channel downmix is given below. With 1 channel passive downmix configuration, only the W channel, P (p₁, p₂, p₃) parameters and P_{d} (d₁, d₂, d₃) parameters are coded and sent to decoder. P corresponds to prediction coefficients indicating how much of side channels (Y, X, and Z) can be predicted from the W channel. P_{d} parameters indicate the residual energy in Y, X and Z channels once the prediction component is taken out.

In the passive downmix coding scheme, the side channels Y, X, and Z are predicted at the decoder from the transmitted downmix W channel; using three prediction parameters P. The missing energy in the side channels is filled up by adding scaled versions of the decorrelated downmix D(W) using the decorrelation parameters Pa. For passive downmixing, reconstruction of FOA input may be determined by:

$${U}_{pas} = pW + {P}_{d} D ( W ) .$$

where p=[1 p₁ p₂ p₃] and P_{d}=[0 d₁ d₂ d₃]^{T}, and D(W) describes the decorrelator outputs with the W channel provided as input to the decorrelator block. Uₚₐₛ is the reconstructed FOA output at the decoder. Note that assuming perfect decorrelators and no quantization of prediction and decorrelator parameters, this scheme achieves perfect reconstruction in terms of the input covariance matrix.

In an example encoder implementation, prediction coefficients for the Y channel can be determined by:

$${p}_{1} = \frac{{R}_{YW}}{{R}_{WW}}$$

In the equation given above, R_{YW} is the covariance of the W and Y channels and R_{WW} is the variance of the W channel.

Similarly, predictions for the other side channels (p₂ for the X channel and p₃ for the Z channel) can be determined.

Residual side channels can be determined by:

$${Y}^{′} = Y - {p}_{1} * W$$

$${X}^{′} = X - {p}_{2} * W$$

$${Z}^{′} = Z - {p}_{3} * W$$

In an example implementation, decorrelation parameters d₁ for the Y channel are determined by:

$${d}_{1} = \sqrt{\frac{{R}_{Y ′ Y ′}}{{R}_{WW}}}$$

Here R_{Y′Y′} is the variance of residual channel Y′ and R_{WW} is the variance of the W channel. Similarly, decorrelation parameters for the other side residual channels (d₂ for the X′ channel and d₃ for the Z′ channel) can be determined.

One potential problem with a decorrelator is that transients in the input audio signal may be smeared across time in the output channels. By way of example, a transient, such as percussive sounds or other types of transients, may be smeared across time in multiple channels generated by the decorrelator, which may add undesirable reverberation in the frame with transients. Another problem is that decorrelated signals generated by a decorrelator may still have considerable energy even when the input signal has a sudden offset. It should be noted that, as used herein, the term “offset” is generally used to refer to the ending or stop of a dominating element or component of an audio signal. In other words, in instances in which an input signal to a decorrelator includes a sudden stop or offset, the decorrelated signals may include considerable energy that smears the offset. This may in turn create artifacts in the reconstructed signals generated based on the decorrelated signals.

Ducking may be used to duck, or attenuate, transients prior to providing an input audio signal to a decorrelator. For example, ducking the transient prior to generating the decorrelated signal(s) may prevent the transient from being smeared across time in the generated decorrelated signal(s). Similarly, ducking may be performed on an output of the decorrelator to attenuate the decorrelated signal(s) in instances in which there is an offset in the input audio signal. However, ducking is conventionally performed on a broadband basis. In other words, all frequency bands of an audio signal are ducked with the same gains. This may create artifacts and decrease audio quality. For example, in an instance in which there is a transient, applying ducking gains to an input audio signal in a broadband manner may duck high frequency content, which may be desirable due to the transient. However, applying ducking gains in a broadband manner may additionally duck lower frequency content, such as bass sounds, which may decrease the overall audio quality and/or create distortions in the overall audio content. To solve the problem of ducking being applied equivalently across all frequency bands, some conventional techniques may apply ducking in a frequency-banded domain when using a multi-band decorrelator. However, due to the computational complexity of implementing a decorrelator, implementing multiple instances of a decorrelator, each operating on a different frequency band, may greatly increase computational complexity, leading to excessive use of computational resources, and the like.

Described herein are techniques for applying ducking gains on a per-frequency band basis. In particular, ducking gains are determined and applied on a frequency band by frequency band basis. This may allow, for example, ducking gains to be differently applied for low frequency content as compared to high frequency content. In some implementations, the ducking gains may be input ducking gains, applied to an input audio signal prior to providing the input audio signal to a decorrelator. Input ducking gains may serve to duck transient signals prior to the transient being provided to the decorrelator, thereby preventing the transient from “entering” the decorrelator. In some implementations, the ducking gains may additionally or alternatively be output ducking gains, applied to a decorrelated signal generated by a decorrelator. Output ducking gains may serve to duck sustained signals in the generated decorrelated signal(s) that correspond to an offset in the input signal, thereby restoring the offset of the input signal in the decorrelated signal(s). It should be noted that, although ducking gains may be determined and applied on a per-frequency band basis, decorrelation may be performed on a broadband basis. Because a decorrelator may be computationally intensive to implement, applying ducking on a per-frequency band basis while performing decorrelation on a broadband basis may improve computational efficiency by implementing only one instance of a decorrelator, while concurrently improving overall audio quality, by applying ducking gains in a selective manner that considers frequency of the audio content.

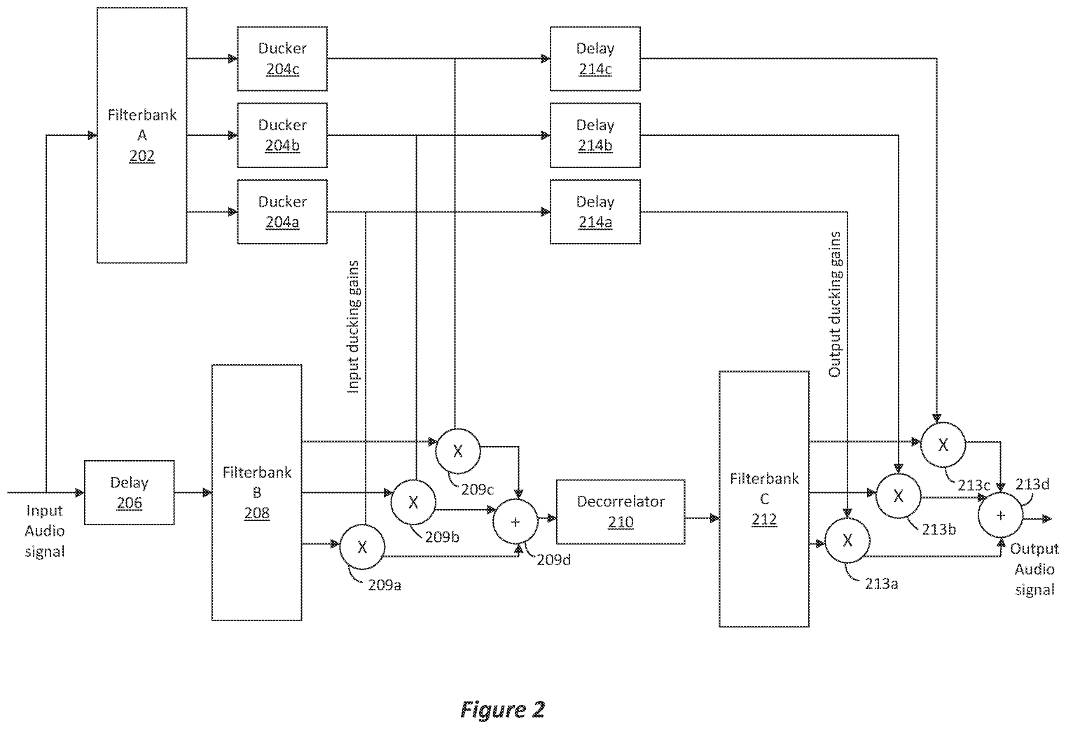

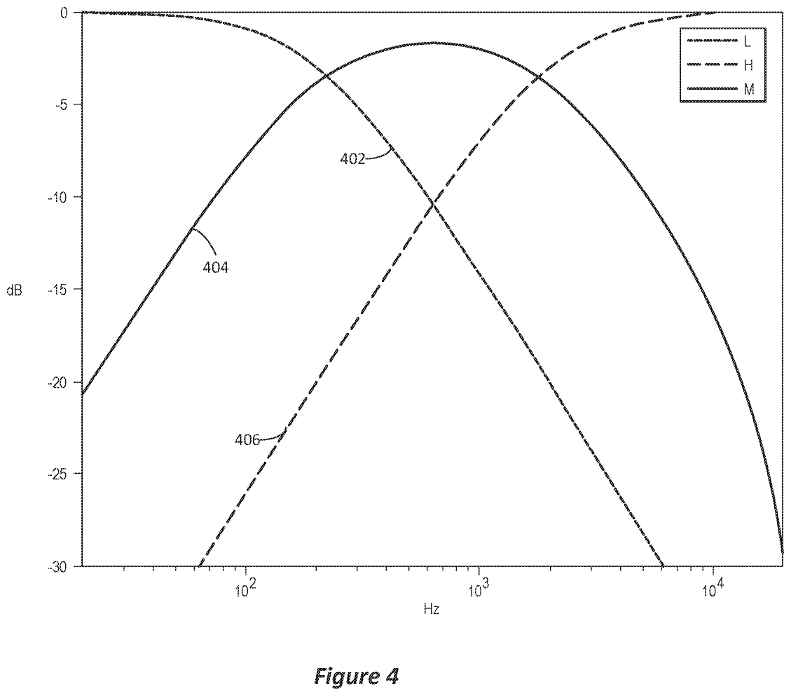

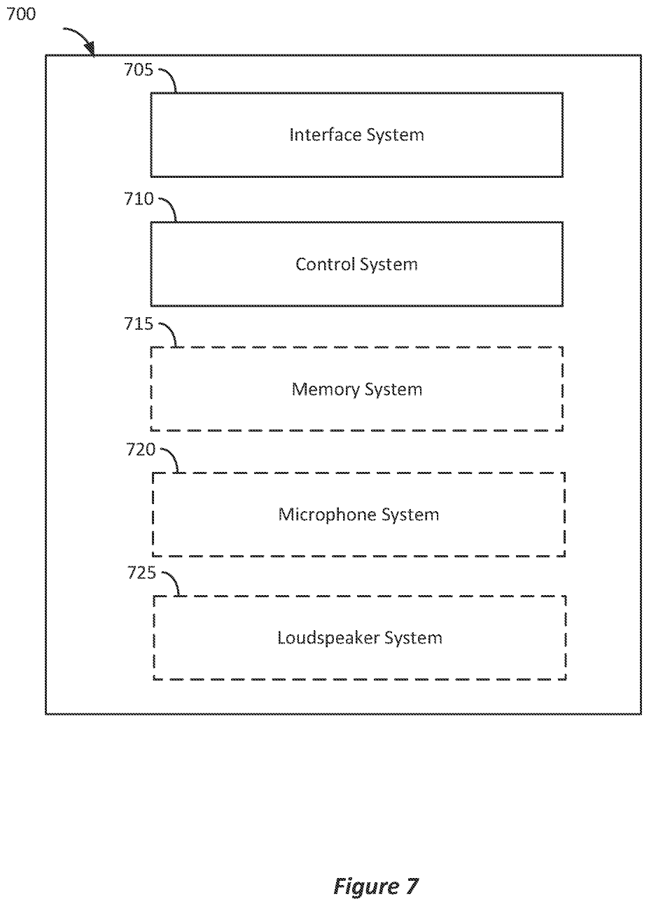

FIG. 2 illustrates a block diagram of an example system that may be used by a decoder to implement multi-band ducking according to some embodiments. It should be noted that various blocks of the system shown in FIG. 2 may be implemented using one or more control systems of a device, such as the control system shown in and described below in connection with FIG. 7. As shown in FIG. 2, an input audio signal, or a frame of an input audio signal, is provided to a first filterbank 202 (which is depicted in FIG. 2 as “Filterbank A”). In some implementations, first filterbank 202 may separate the input audio signal into any suitable number of frequency bands, such as two frequency bands, three frequency bands, eight frequency bands, ten frequency bands, 16 frequency bands, etc. In the example shown in FIG. 2, first filterbank 202 separates the input audio signal into three frequency bands, which may correspond to low frequencies, middle frequencies, and high frequencies, respectively. Examples of frequency ranges for an implementation involving three frequency bands are shown in FIG. 4 and described below.

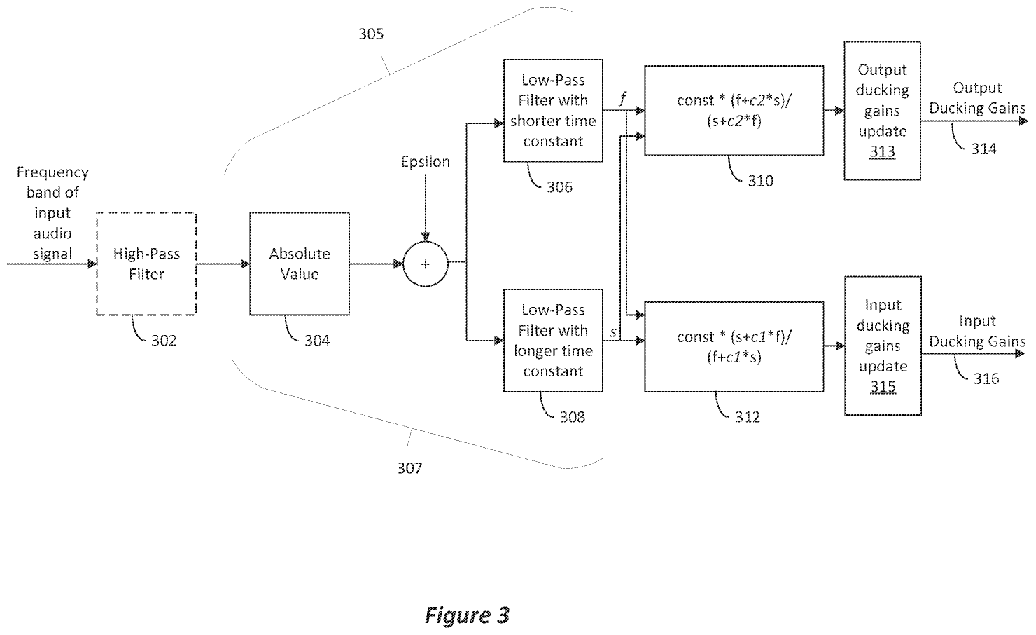

Each frequency band may be provided to an instance of a ducker block. For example, because first filterbank 202 separates the input audio signal into three frequency bands, there are three ducker blocks illustrated in FIG. 2, which are depicted as ducker 204a, ducker 204b, and ducker 204c. Each ducker block may generate input ducking gains and/or output ducking gains. In some implementations, ducking gains may be determined based on a ratio of outputs of two envelope trackers, each having a different time constant. An envelope tracker may be implemented using an absolute value (rectifier) block followed by a low-pass filter. For example, input ducking gains may be determined based on a ratio of an output of a low pass filter having a long time constant to an output of a low pass filter having a short time constant. In other words, input ducking gains may be determined based on a ratio of slow envelope tracking to fast envelope tracking. Conversely, output ducking gains may be determined based on a ratio of an output of a low pass filter having a short time constant to an output of a low pass filter having a long time constant. In other words, output ducking gains may be determined based on a ratio of fast envelope tracking to slow envelope tracking. Examples of long time constants include 60 milliseconds, 70 milliseconds, 80 milliseconds, 90 milliseconds, or the like. Examples of short time constants include 3 milliseconds, 4 milliseconds, 5 milliseconds, 10 milliseconds, or the like. It should be noted that each ducker block instance may take, as an input, an output of first filterbank 202 corresponding to a particular frequency band and generate ducking gains applicable to that particular frequency band. A more detailed example of a ducker block is shown in and described below in connection with FIG. 3.

The input audio signal may be provided to a delay block 206. The delayed version of the input audio signal may be provided to a second filterbank 208 (depicted in FIG. 2 as “Filterbank B”). Delay block 206 may serve to delay the input audio signal by an amount that time-aligns the input audio signal, after being separated into multiple frequency bands by second filterbank 208, to the timing of the input audio signal for which ducking gains were determined by ducker blocks 204a, 204b, and 204c. It should be noted that delay block 206 may be implemented in connection with a broadband ducker implementation (e.g., in which filterbanks 202 and 208 are not implemented). Example delays that may be imposed by delay block 206 include 1.5 milliseconds, 2 milliseconds, 2.5 milliseconds, or the like. In some implementations, the delay imposed by delay block 206 may be a delay that would be utilized in a broadband ducker system that is then modified based at least in part on a delay imposed by first filterbank 202 and/or a delay imposed by second filterbank 208.

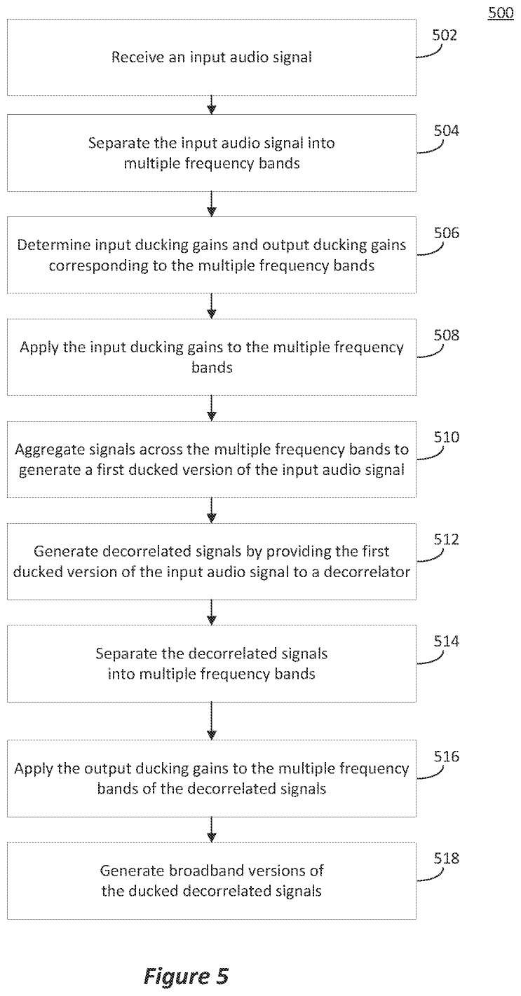

Input ducking gains, determined by ducker blocks 204a, 204b, and 204c, may be applied on a per-frequency band basis to the frequency bands of the delayed version of the input audio signal. For example, a first input ducking gain corresponding to a first frequency band may be determined based on a first frequency band of the first filterbank 202. Continuing with this example, the first input ducking gain may then be applied to a corresponding instance of the first frequency band of second filterbank 208. As a more particular example, input ducking gains may be applied by multiplying an input ducking gain with a corresponding frequency band signal gain application blocks 209a, 209b, and 209c. It should be noted that, in some implementations, first filterbank 202 and second filterbank 208 may be different instances of the same filterbank, e.g . . . one having the same number of frequency bands, the same frequency response, the same type of filters, or the like. Conversely, in some implementations, first filterbank 202 and second filterbank 208 may differ in any one or more characteristics, such as number of frequency bands, cutoff frequencies of various frequency bands, types of filters used, etc. It should be noted that application of the input ducking gains may serve to duck, or attenuate, transients in the input audio signal. As will be described below in more detail in connection with FIGS. 3 and 5, input ducking gains applied to higher frequency bands may be higher than input ducking gains applied to lower frequency bands, thereby causing high frequency signals to be ducked, or attenuated, more strongly than lower frequency signals.

A broadband ducked signal may be generated after input ducking gains have been applied. For example, after input ducking gains have been applied on a per-frequency band basis of the set of frequency bands of second filterbank 208, the frequency bands may be combined, e.g., by summing, to generate a broadband signal. As a more particular example, the frequency bands may be summed, or aggregated, via an aggregation block 209d. The broadband signal may then be provided to a decorrelator 210. Decorrelator 210 may generate one or more decorrelated signals. In some implementations, the number of decorrelated signals generated by decorrelator 210 may depend on a number of signals to be parametrically reconstructed by the decoder, as described above in connection with FIG. 1. For example, in an instance in which the reconstructed audio signal is a stereo signal, decorrelator 210 may generate one decorrelated signal, which may be used to upmix a signal downmixed signal to generate the original two signals. As another example, in an instance in which the reconstructed audio signal includes four channels, and in which there is one downmixed signal, decorrelator 210 may generate three decorrelated signals, each of which may be used to reconstruct three signals that were parametrically encoded by the encoder.

The one or more decorrelated signals may be provided to a third filterbank 212 (depicted as “Filterbank C” in FIG. 2). Third Filterbank 212 may separate each of the one or more decorrelated signals into multiple frequency bands, e.g., two frequency bands, three frequency bands, eight frequency bands, 16 frequency bands, etc. In some embodiments, third filterbank 212 may be another instance of first filterbank 202 and/or second filterbank 208. Conversely, in some implementations, third filterbank 212 may be different than first filterbank 202 and/or second filterbank 208 in any characteristics, such as cutoff frequencies of various frequency bands, types of filters used, etc. It should be noted that, in some implementations, third filterbank 212 may be replicated for each decorrelated signal generated by decorrelator 210.

Output ducking gains, each determined based on a frequency band of first filterbank 202 and generated by ducker blocks 204a, 204b, and 204c may be delayed by corresponding delay blocks 214a, 214b, and 214c. Delay blocks 214a, 214b, and 214c may serve to delay the output ducking gains such that the output ducking gains can be time-aligned with the frequency bands of third filterbank 212. In some embodiments, a delay imposed by each of delay blocks 214a, 214b, and 214c may be based at least in part on a delay generated by third filterbank 212. The delayed output ducking gains may then be applied on a per-frequency band basis to each of the one or more decorrelated signals. For example, output ducking gains may be applied by multiplying an output ducking gain by a corresponding frequency band signal via gain application blocks 213a, 213b, and 213c. It should be noted that output ducking gains may serve to duck, or attenuate, offsets in the input audio signal. An example of an offset is a sudden stopping of the input audio signal.

After application of the output ducking gains on a per-frequency band basis, broadband versions of each decorrelated signal may be generated. For example, the ducked frequency bands may be combined, e.g., summed, to generate a ducked, broadband decorrelated signal. As a more particular example, the ducked frequency bands may be summed, or aggregated, via aggregation block 213d. The ducked, broadband decorrelated signal may be usable by the decoder for upmixing a downmixed signal and generating a reconstructed audio signal.

It should be noted that first filterbank 202, second filterbank 208, and/or third filterbank 212 may be implemented in any suitable manner. For example, a filterbank may be implemented as an infinite impulse response (IIR) filterbank. As another example, a filterbank may be implemented as a finite impulse response (FIR) filterbank. Various filterbank implementations may have advantages and disadvantages. For example, some filterbank implementations may have longer delays than others. As described above, various delay blocks may be implemented to account for delays imposed by a filterbank, e.g., to ensure that signals are time-aligned prior to application of ducking gains. It should be noted that the filterbanks may enable and/or approximate “exact reconstruction.” where the sum of the unmodified bands is substantially the same as the input signal to the filterbank, or a delayed version thereof.

As described above, in some implementations, input ducking gains and output ducking gains may be determined by providing a particular frequency band of an input audio signal to two envelope trackers and determining a ratio of the outputs of the two trackers. In some embodiments, each envelope tracker may be associated with a corresponding low-pass filter. In some embodiments, the two low-pass filters may have two different time constants, one time constant being substantially longer than the other. Examples of a shorter time constant are 3 milliseconds, 4 milliseconds, 5 milliseconds, 10 milliseconds, or the like. Examples of a longer time constant are 60 milliseconds, 70 milliseconds, 80 milliseconds, 100 milliseconds, or the like. Each low-pass filter may effectively perform envelope tracking on the particular frequency band of the input audio signal which is provided as an input to the low-pass filter, where one low-pass filter performs slow envelope tracking and the other low-pass filter performs fast envelope tracking. Each low-pass filter may be characterized by the numerator filter coefficients b and the denominator filter coefficients a, where b=[1−c] and a=[1,−c]. Here, c may be determined based on the time constant of the filter, where c=exp(−1/(fc*sampling_rate)), where t_{c} represents the time constant of the filter in seconds. Given a-3 dB cutoff, a low-pass filter with a time constant of 5 milliseconds may have a cutoff frequency of around 32.2 Hz, and a filter with a time constant of 80 milliseconds may have a cutoff frequency of around 2.2 Hz. In some embodiments, an input ducking gain for a particular frequency band may be determined based on a ratio of an output of the low-pass filter with the longer time constant to an output of the low-pass filter with the shorter time constant. In other words, the input ducking gain may correspond to a ratio of the slow envelope tracking to fast envelope tracking. Conversely, an output ducking gain for a particular frequency band may be determined based on a ratio of an output of the low-pass filter with the shorter time constant to an output of the low-pass filter with the longer time constant. In other words, the output ducking gain may correspond to a ratio of the fast envelope tracking to slow envelope tracking.

In some implementations, prior to providing a particular frequency band of the input audio signal to the two envelope trackers, a high-pass filter may be applied. The high-pass filter may serve to flatten the spectrum and/or avoid bias in the presence of low-frequency rumbling. In some implementations, the cutoff frequency of the high-pass filter may depend on the frequency band of the input audio signal that the high-pass filter is being applied to. For example, a lower cutoff may be used for lower frequency bands relative to higher frequency bands. In one example, a cutoff of 3 kHz may be used for higher frequency bands, whereas a cutoff of 1 kHz may be used for lower frequency bands. Examples of cutoff frequencies for the high-pass filter include 1 kHz, 2 kHz, 3 kHz, 5 kHz, or the like. In some implementations, the high-pass filter may be omitted for some frequency bands.

FIG. 3 shows a schematic diagram of an example ducker instance in accordance with some embodiments. It should be noted that various blocks of the example ducker instance shown in FIG. 3 may be implemented by one or more control systems of a device, such as the control system shown in and described below in connection with FIG. 7. The ducker may take a particular frequency band of the input audio signal as an input, and may generate input ducking gains and/or output ducking gains applicable to that frequency band as outputs. As described above, the ducker may take, as an input, a frequency band of an input audio signal. For example, the frequency band may be a frequency band of first filterbank 202, as shown in and described above in connection with FIG. 2. The input ducking gains and/or output ducking gains may be applicable to this particular frequency band. It should be noted that the example ducker instance shown in FIG. 3 may be essentially replicated for each frequency band of first filterbank.

As illustrated, the frequency band of the input audio signal may optionally be high-pass filtered using a high-pass filter 302. In some implementations, a cutoff frequency of high-pass filter 302 may depend at least in part on the frequency band of the input audio signal being processed by the ducker instance. For example, a higher cutoff frequency may be used for higher frequency bands, and vice versa. Examples of cutoff frequencies for the high-pass filter include 1 kHz, 2 kHz, 3 kHz, 5 kHz, or the like.

The frequency band of the input audio signal, or, if used, the high-pass filtered version of the frequency band of the input audio signal, may be provided to fast envelope tracker 305 and to slow envelope tracker 307. Each envelope tracker may include an absolute value computation block 304 configured to generate an absolute value of the signal. It should be noted that, in some implementations, a relatively small value, depicted in FIG. 3 as “epsilon” may be added to the absolute value of the signal. This may prevent divide by zero errors when input ducking gains and/or output ducking gains are determined, as described below. As illustrated in FIG. 3, fast envelope tracker 305 includes a first low-pass filter 306, and slow envelope tracker 307 includes a second low-pass filter 308. As illustrated in FIG. 3, first low-pass filter 306 may have a shorter time constant compared to the second low-pass filter 308. Examples of shorter time constants include 3 milliseconds, 4 milliseconds, 5 milliseconds, 10 milliseconds, or the like. Examples of a longer time constant are 60 milliseconds, 70 milliseconds, 80 milliseconds, 90 milliseconds, 100 milliseconds, or the like.

The output of first low-pass filter 306 (depicted in FIG. 3 as “f.” representing fast envelope tracking) and the output of second low-pass filter 308 (depicted in FIG. 3 as “s,” representing slow envelope tracking) are provided to output ducking gains determination block 310. Similarly, the output of first low-pass filter 306 and the output of second low-pass filter 308 are provided to input ducking gains determination block 312. Output ducking gains may be determined based at least in part on a ratio of fast envelope tracking to slow envelope tracking. In particular, as illustrated in FIG. 3, if the output of first low-pass filter 306 is represented as f (i.e., for fast envelope tracking), and the output of second low-pass filter 308 is represented as s (i.e., for slow envelope tracking), an initial set of output ducking gains may be determined by:

$$output ducking gains = const * \frac{( f + {c}_{2} * s )}{( s + {c}_{2} * f )}$$

An initial set of input ducking gains may be determined by:

$$input ducking gains = const * \frac{( s + {c}_{1} * f )}{( f + {c}_{1} * s )}$$

It should be noted that const, which represents a multiplicative constant, may be the same for output ducking gains and input ducking gains, or may be different for output ducking gains compared to input ducking gains. Example values of const include 1, 1.05, 1.1, 1.15, 1.2, etc. Additionally, it should also be noted that the constants c₁ and c₂ may be different for each frequency band. In particular, the values of c₁ and c₂ may represent an amount of input ducking and output ducking, respectively, that is to be applied with respect to the frequency band. In other words, c₁ and c₂ may serve as frequency band dependent corrections to the ducking gains. By way of example, it may be advantageous to have no ducking in the lowest frequency bands. Accordingly, for the lowest frequency bands, c₁ and c₂ may be 1. As another example, relatively higher amounts of ducking may be applied for the highest frequency bands. Accordingly, for the highest frequency band, c₁ and c₂ may be 0, thereby causing the input ducking gains and the output ducking gains to be determined as a ratio based on the outputs of the envelope trackers with no frequency band dependent correction to the ratio. It should be noted that, for a particular frequency band, c₁ and c₂ may be the same as each other, or may be different from each other. In some implementations, c₁ and c₂ may be any suitable value within a range of 0 to 1, inclusive.

The initial set of output ducking gains may be provided to an output ducking gains update block 313 to determine output ducking gains 314. Similarly, the initial set of input ducking gains may be provided to an input ducking gains update block 315 to determine input ducking gains 316. In some implementations, output ducking gains update block 313 and input ducking gains update block 315 may be configured to perform smoothing and/or ducking release control to avoid undesirable sudden changes in ducking gains applied. By way of example, in an instance in which the input audio signal includes a transient, there may be a sudden change in input ducking gains, e.g., as determined by input ducking gains determination block 312, in order to duck the transient. Continuing with this example, input ducking gains update block 315 may then modify an initial set of input ducking gains determined after the transient such that the modified input ducking gains smoothly transition after the sudden change in input ducking gains due to the transient.

An example implementation of block 313 and 315 is described below. Given initial values of input ducking gains represented as in_duck_gains_init and initial values of output ducking gains represented as out_duck_gains_init, and the actual input ducking gains (represented as in_duck_gains_act) and actual output ducking gains (represented as out_duck_gains_act) may be determined by the following pseudo-code:

For each sample s:

in_duck_state = (in_duck_state − 1) *in_duck_c + 1
If (in_duck_gains_init (s) < in_duck_state)
in_duck_state = in_duck_gains_init (s)
in_duck_gains_act(s) = in_duck_state

In the above, in_duck_state represents the gain state carried from one time frame to another. An initial value of in_duck_state can be set between 0 and 1. In the pseudo-code example given above, in_duck_c represents the release constant that controls how quickly or slowly ducking gains are released. In other words, in_duck_c may be used to control the transition of ducking gains from low to high value. In the technique described above, input ducking gains are released according to the release constant, and are then updated responsive to a new ducking gain sample being smaller than the released value.

A similar approach may be utilized for output ducking gains, as shown in the pseudo-code sample given below.

For each sample s:

out_duck_state = (out_duck_state − 1) *out_duck_c + 1
If (out_duck_gains_init (s) < out_duck_state)
out_duck_state = out_duck_gains_init (s)
out_duck_gains_act(s) = out_duck_state

In the pseudo-code example given above, out_duck_state represents the gain state carried from one time frame to another. An initial value of out_duck_state can be set between 0 and 1. In the example given above, out_duck_c is the release constant that controls how quickly or slowly ducking gains are released. In other words, out_duck_c may be used to controls the transition of ducking gains from low to high values. In the example given above, output ducking gains may be released according to the release constant, and may then be updated responsive to a new ducking gain sample being smaller than the released value.

As described above, a decoder may implement various filterbanks to separate an audio signal into multiple signals that are band limited based on the frequency bands of the filterbank. For example, a filterbank may separate an input audio signal into multiple frequency bands to determine input ducking gains and/or output ducking gains on a per-frequency band basis. As another example, a filterbank may separate an input audio signal into multiple frequency bands to apply input ducking gains on a per-frequency band basis. As yet another example, a filterbank may separate a broadband decorrelated signal, which may have had input ducking gains applied, into multiple frequency bands prior to applying output ducking gains on a per-frequency band basis. As described above, in instances in which multiple filterbanks are implemented, the filterbanks may be multiple instances of the same filterbank, or may vary in one or more characteristics, such as number of frequency bands, frequency responses, type of filters used, or the like. A filterbank may separate a signal into any suitable number of frequency bands, such as two, three, five, eight, 16, etc. In one example, a filterbank separates a signal into three frequency bands, corresponding to low frequencies, middle frequencies, and high frequencies. Example types of filters that may be used include infinite impulse response (IIR) filters, finite impulse response (FIR) filters, or the like. Each type of filter may be associated with different complexities which may allow tradeoffs between filtering characteristics and computational complexity in implementation.

FIG. 4 shows the frequency responses of the bands of an example filterbank that may be used in accordance with some embodiments. The example shown in FIG. 4 utilizes three first-order IIR filters with zero delay. The three filters correspond to a low frequency band 402, a middle frequency band 404, and a high frequency band 406. In the example shown in FIG. 4, low frequency band 402 has a cutoff frequency of 200 Hz, and high frequency band 406 has a cutoff frequency of 2 kHz. Middle frequency band 404 is derived from low frequency band 402 and high frequency band 406, e.g., to obtain perfect reconstruction of a signal passed through the filterbank. Note that, perfect reconstruction of a signal may enable a signal to remain effectively unmodified in instances in which ducking gains are determined to be 1 or close to 1. It should be noted that the example shown in FIG. 4 is merely exemplary, and, filterbanks implemented by a decoder may differ from that illustrated in FIG. 4 in number of frequency bands, cutoff frequencies of each frequency band, types of filters used, complexity, delay, or the like.

FIG. 5 is a flowchart of an example process 500 for applying ducking gains on a per-frequency band basis according to some embodiments. In some implementations, blocks of process 500 may be implemented using a control system of a decoder device. Such a control system is shown in and described below in connection with FIG. 7. In some embodiments, blocks of process 500 may be performed in an order other than what is shown in FIG. 5. In some implementations, two or more blocks of process 500 may be performed substantially in parallel. In some implementations, one or more blocks of process 500 may be omitted.

Process 500 can begin at 502 by receiving an input audio signal, or a frame of the input audio signal. In some implementations, the input audio signal may be received by a receiver device, such as an antenna, of the decoder. In some embodiments, the input audio signal may be received at the decoder from an encoder device that transmits the input audio signal. It should be noted that, in some implementations, the received input audio signal may be a downmixed audio signal that has been downmixed by an encoder prior to transmission to the decoder. In some such implementations, the decoder may additionally receive metadata, or side information, that may be usable to upmix the downmixed signal, e.g., to generate a reconstructed audio signal, as described above in connection with FIG. 1.

At 504, process 500 can separate the input audio signal into multiple frequency bands. For example, in some implementations, process 500 can provide the input audio signal to a first filterbank, which separates the input audio signal into corresponding frequency bands. Any suitable number of frequency bands may be used, such as two, three, five, eight, 16, or the like. In one example, the input audio signal may be separated into three frequency bands corresponding to a low frequency band, a middle frequency band, and a high frequency band, similar to the example shown in and described above in connection with FIG. 4.

At 506, process 500 may determine input ducking gains and/or output ducking gains corresponding to the multiple frequency bands. For example, as shown in and described above in connection with FIG. 3, process 500 may apply two envelope trackers to each frequency band, a first envelope tracker corresponding to fast envelope tracking and the second envelope tracker corresponding to slow envelope tracking. Process 500 may apply, as part of envelope tracking, two low-pass filters to each frequency band after absolute value computation, e.g., rectification, the first low-pass filter having a relatively short time constant, and the second low-pass filter having a longer time constant. The first low-pass filter may generate an output generally referred to herein as f, representing fast envelope tracking, and the second low-pass filter may generate an output generally referred to herein as s, representing slow envelope tracking. As shown in and described above in connection with FIG. 3, the input ducking gains may be determined by:

$$input ducking gains = const * \frac{( s + {c}_{1} + f )}{( f + {c}_{1} * s )}$$

The output ducking gains may be determined by:

$$output ducking gains = const * \frac{( f + {c}_{2} * s )}{( s + {c}_{2} * f )}$$

As shown in the equations above, the input ducking gains and the output ducking gains may be determined based on a ratio of the outputs of the two envelope trackers, where the ratio is modified based on constants (represented in the equations above as c₁ and c₂) selected for each frequency band. By way of example, the input ducking gains may generally be determined based on a ratio of the slow envelope tracking to the fast envelope tracking, where the amount that each is weighted in the ratio is modified by the constant c₁. Similarly, the output ducking gains may generally be determined based on a ratio of the fast envelope tracking to the slow envelope tracking, where the amount that each is weighted in the ratio is modified by the constant c₂. As described above, the input ducking gains and/or the output ducking gains may be subsequently modified, e.g., using an input ducking gains update block and/or an output ducking gains update block, as described above in connection with FIG. 3.

It should be noted that, in some implementations, prior to determining the input ducking gains and/or output ducking gains for a particular frequency band, process 500 may obtain, or determine, for the particular frequency band, values of c₁ and c₂. In some embodiments, values of c₁ and c₂ may be fixed for a particular frequency band. By way of example, in some embodiments, c₁ and c₂ may be fixed at 1 for the lowest frequency band, causing the lowest frequency band to not be ducked. Continuing with this example, in some embodiments, c₁ and c₂ may be set at 0 for the highest frequency band, causing the input ducking gains to be determined based on a ratio of slow envelope tracking to fast envelope tracking with no adjustment, and causing the output ducking gains to be determined based on a ratio of fast envelope tracking to slow envelope tracking with no adjustment.

Additionally, it should be noted that, for a particular frequency band of the multiple frequency bands, a high-pass filter may be applied prior to providing the input signal to the fast and slow envelope trackers, as shown in and described above in connection with FIG. 3. The high-pass filter may serve to flatten the spectrum and/or avoid bias in the presence of low frequency rumble. In some implementations, the high-pass filter may only be applied for a subset of the multiple frequency bands. In some embodiments, a cutoff frequency of the high-pass filter may differ for different frequency bands. As described above in connection with FIG. 3, example cutoff frequencies include 1.5 kHz, 2 kHz, 2.5 kHz, 3 kHz, 3.5 kHz, 4 kHz, or the like.

At 508, process 500 can apply the input ducking gains to the multiple frequency bands. As shown in and described above in connection with FIG. 2, in some embodiments, process 500 may apply the input ducking gains by first delaying the input audio signal by an amount determined at least in part by a delay imposed by the first filterbank utilized in connection with block 504, and subsequently applying a second filterbank to the delayed input audio signal to separate the delayed input audio signal into multiple frequency bands. The input ducking gains may then be applied to the multiple frequency bands of the delayed input audio signal, for example, by multiplying a signal at a particular frequency band by the corresponding one or more input ducking gains for that frequency band. It should be noted that, in some implementations, for a particular frequency band, there may be multiple time-varying input ducking gains, such that each sample of the band-limited audio signal in time domain may be ducked by the corresponding sample of the input ducking gain. In some embodiments, the second filterbank may be a second instance of the first filterbank. In other words, in some implementations, the filterbank used to determine the ducking gains may have the same characteristics as the filterbank used to generate the multiple frequency bands of the input audio signal to which the input ducking gains are applied. Conversely, in some implementations, the first filterbank may differ from the second filterbank in one or more characteristics, such as frequency responses, number of frequency bands, types of filters used, etc.

At 510, process 500 may aggregate signals across the multiple frequency bands to generate a first ducked version of the input audio signal. For example, in some embodiments, process 500 may sum the multiple frequency bands. In some implementations, process 500 may generate a time-domain version of the aggregated signal to generate the first ducked version of the input audio signal.

At 512, process 500 may generate decorrelated signals by providing the first ducked version of the input audio signal to a decorrelator. In some implementations, one or more decorrelated signals may be generated. In some embodiments, the number of decorrelated signals generated by the decorrelator may depend on the number of signals to be parametrically reconstructed from metadata or side information, as shown in and described above in connection with FIGS. 1 and 2.

At 514, process 500 can separate the decorrelated signals into multiple frequency bands. In some implementations, each decorrelated signal may be separated using a filterbank, as shown in and described above in connection with FIGS. 2 and 4. In some embodiments, the filterbank may be the same as that used in connection with blocks 504 and/or 508. Conversely, in some embodiments, the filterbank may have one or more different characteristics than the filterbanks used in connection with blocks 504 and/or 508.

At 516, process 500 can apply the output ducking gains to the multiple frequency bands of the decorrelated signals, the output ducking gains having been determined at block 506. In some implementations, output ducking gains may be applied to a particular frequency band by multiplying, for that frequency band, the corresponding one or more output ducking gains. The output ducking gains may then be applied to the multiple frequency bands of the decorrelated signals, for example, by multiplying a signal at a particular frequency band by the corresponding one or more output ducking gains for that frequency band. It should be noted that, in some implementations, for a particular frequency band, there may be multiple time-varying output ducking gains, such that each sample of the band-limited decorrelated audio signal in time domain may be ducked by the corresponding sample of the output ducking gain. In some implementations, output ducking gains may be separately applied to each decorrelated signal.

At 518, process 500 can generate broadband versions of the ducked decorrelated signals. For example, for a particular decorrelated signal, process 500 can sum the signals of the multiple frequency bands after output ducking gains have been applied. Continuing with this example, process 500 can generate time domain representations of the summed, or aggregated signal to generate a ducked decorrelated signal.

It should be noted that although process 500 describes applying both input ducking gains and output ducking gains, in some implementations, either input ducking gains or output ducking gains may be applied without the other. For example, input ducking gains may be applied to duck transients in particular frequency bands prior to providing the signal to a decorrelator. Continuing with this example, output ducking gains may not be applied to the one or more decorrelated signals, e.g., in instances in which there is no offset present. As another example, output ducking gains may be applied to duck an offset portion of one or more decorrelated signals generated by a decorrelator, without having input ducking gains previously applied to the signal provided to the decorrelator. As a more particular example, in an instance in which the input audio signal does not include particular types of signals, such as transients, input ducking gains may not be applied.

Additionally, it should be noted that each ducked decorrelated signal may be utilized by the decoder to upmix the downmixed input audio signal. For example, as shown in and described above in connection with FIG. 1, the ducked decorrelated signals may be provided to a spatial reconstruction codec which takes the ducked decorrelated signal(s) and side information, or metadata, provided by the encoder, and upmixes the downmixed input audio signal. In some implementations, the upmixed audio signals may then be rendered, for example, to create a spatial perception when the rendered audio signal is presented. In some implementations, the decoder device may cause the rendered audio signal to be presented, for example, by one or more loudspeakers, headphones, etc.

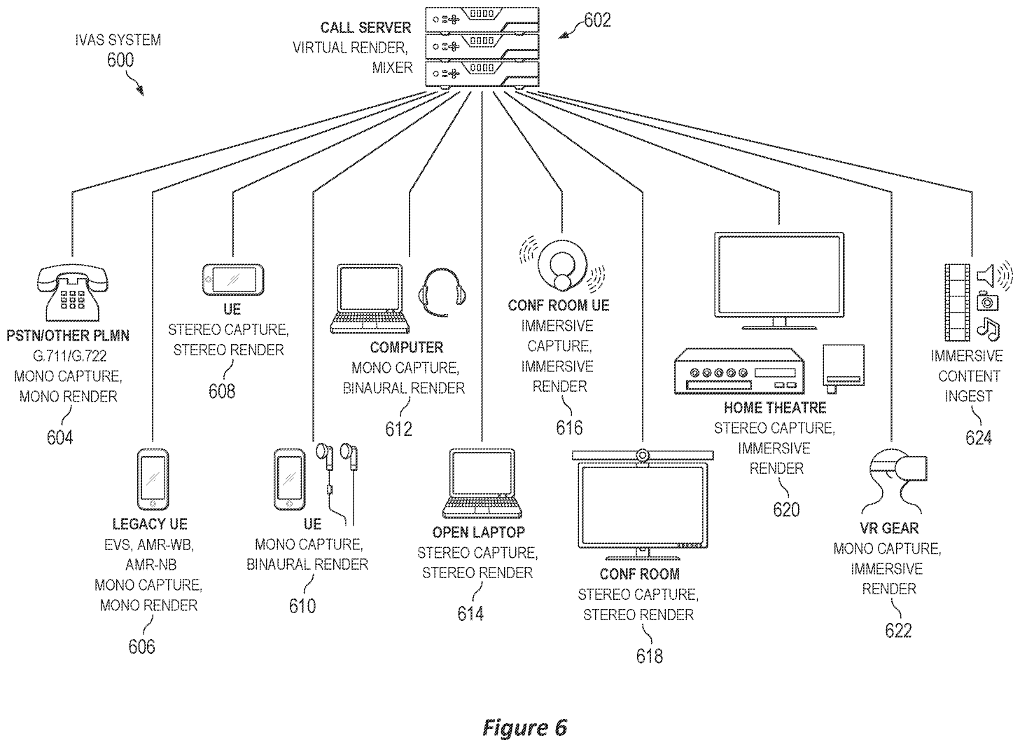

FIG. 6 illustrates example use cases for an IVAS system 600, according to an embodiment. In some embodiments, various devices communicate through call server 602 that is configured to receive audio signals from, for example, a public switched telephone network (PSTN) or a public land mobile network device (PLMN) illustrated by PSTN/OTHER PLMN 604. Use cases support legacy devices 606 that render and capture audio in mono only, including but not limited to: devices that support enhanced voice services (EVS), multi-rate wideband (AMR-WB) and adaptive multi-rate narrowband (AMR-NB). Use cases also support user equipment (UE) 608 and/or 614 that captures and renders stereo audio signals, or UE 610 that captures and binaurally renders mono signals into multi-channel signals. Use cases also support immersive and stereo signals captured and rendered by video conference room systems 616 and/or 618, respectively. Use cases also support stereo capture and immersive rendering of stereo audio signals for home theatre systems 620, and computer 612 for mono capture and immersive rendering of audio signals for virtual reality (VR) gear 622 and immersive content ingest 624.

FIG. 7 is a block diagram that shows examples of components of an apparatus capable of implementing various aspects of this disclosure. As with other figures provided herein, the types and numbers of elements shown in FIG. 7 are merely provided by way of example. Other implementations may include more, fewer and/or different types and numbers of elements. According to some examples, the apparatus 700 may be configured for performing at least some of the methods disclosed herein. In some implementations, the apparatus 700 may be, or may include, a television, one or more components of an audio system, a mobile device (such as a cellular telephone), a laptop computer, a tablet device, a smart speaker, or another type of device.

According to some alternative implementations the apparatus 700 may be, or may include, a server. In some such examples, the apparatus 700 may be, or may include, an encoder. Accordingly, in some instances the apparatus 700 may be a device that is configured for use within an audio environment, such as a home audio environment, whereas in other instances the apparatus 700 may be a device that is configured for use in “the cloud,” e.g., a server.

In this example, the apparatus 700 includes an interface system 705 and a control system 710. The interface system 705 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 705 may, in some implementations, be configured for exchanging control information and associated data with audio devices of the audio environment. The control information and associated data may, in some examples, pertain to one or more software applications that the apparatus 700 is executing.

The interface system 705 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 705 may include one or more network interfaces and/or one or more external device interfaces, such as one or more universal serial bus (USB) interfaces. According to some implementations, the interface system 705 may include one or more wireless interfaces. The interface system 705 may include one or more devices for implementing a user interface, such as one or more microphones, one or more speakers, a display system, a touch sensor system and/or a gesture sensor system. In some examples, the interface system 705 may include one or more interfaces between the control system 710 and a memory system, such as the optional memory system 715 shown in FIG. 7. However, the control system 710 may include a memory system in some instances. The interface system 705 may, in some implementations, be configured for receiving input from one or more microphones in an environment.

The control system 710 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 710 may reside in more than one device. For example, in some implementations a portion of the control system 710 may reside in a device within one of the environments depicted herein and another portion of the control system 710 may reside in a device that is outside the environment, such as a server, a mobile device (e.g., a smartphone or a tablet computer), etc. In other examples, a portion of the control system 710 may reside in a device within one environment and another portion of the control system 710 may reside in one or more other devices of the environment. For example, a portion of the control system 710 may reside in a device that is implementing a cloud-based service, such as a server, and another portion of the control system 710 may reside in another device that is implementing the cloud-based service, such as another server, a memory device, etc. The interface system 705 also may, in some examples, reside in more than one device.

In some implementations, the control system 710 may be configured for performing, at least in part, the methods disclosed herein. According to some examples, the control system 710 may be configured for implementing methods of separating an audio signal into multiple frequency bands, determining input ducking gains and/or output ducking gains based on the frequency bands, applying input ducking gains on a per-frequency band, applying a decorrelator on a broadband audio signal, applying output ducking gains on a per-frequency band basis of decorrelated audio signals, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 715 shown in FIG. 7 and/or in the control system 710. Accordingly, various innovative aspects of the subject matter described in this disclosure can be implemented in one or more non-transitory media having software stored thereon. The software may, for example, include instructions for separating an audio signal into multiple frequency bands, determining input ducking gains and/or output ducking gains based on the frequency bands, applying input ducking gains on a per-frequency band, applying a decorrelator on a broadband audio signal, applying output ducking gains on a per-frequency band basis of decorrelated audio signals, etc. The software may, for example, be executable by one or more components of a control system such as the control system 710 of FIG. 7.

In some examples, the apparatus 700 may include the optional microphone system 720 shown in FIG. 7. The optional microphone system 720 may include one or more microphones. In some implementations, one or more of the microphones may be part of, or associated with, another device, such as a speaker of the speaker system, a smart audio device, etc. In some examples, the apparatus 700 may not include a microphone system 720. However, in some such implementations the apparatus 700 may nonetheless be configured to receive microphone data for one or more microphones in an audio environment via the interface system 710. In some such implementations, a cloud-based implementation of the apparatus 700 may be configured to receive microphone data, or a noise metric corresponding at least in part to the microphone data, from one or more microphones in an audio environment via the interface system 710.

According to some implementations, the apparatus 700 may include the optional loudspeaker system 725 shown in FIG. 7. The optional loudspeaker system 725 may include one or more loudspeakers, which also may be referred to herein as “speakers” or, more generally, as “audio reproduction transducers.” In some examples, e.g., cloud-based implementations, the apparatus 700 may not include a loudspeaker system 725. In some implementations, the apparatus 700 may include headphones. Headphones may be connected or coupled to the apparatus 700 via a headphone jack or via a wireless connection, e.g., BLUETOOTH.

Some aspects of present disclosure include a system or device configured, e.g., programmed, to perform one or more examples of the disclosed methods, and a tangible computer readable medium, e.g., a disc, which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor, e.g., a personal computer (PC) or other computer system or microprocessor, which may include an input device and a memory, which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements The other elements may include one or more loudspeakers and/or one or more microphones. A general purpose processor configured to perform one or more examples of the disclosed methods may be coupled to an input device. Examples of input devices include, e.g., a mouse and/or a keyboard. The general purpose processor may be coupled to a memory, a display device, etc.

Another aspect of present disclosure is a computer readable medium, such as a disc or other tangible storage medium, which stores code for performing, e.g., by a coder executable to perform, one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method for processing audio signals, comprising:
receiving, at a decoder, an input audio signal, wherein the input audio signal is a downmixed audio signal;
separating the input audio signal into a first set of frequency bands;
determining a set of ducking gains, a ducking gain of the set of ducking gains corresponding to a frequency band of the first set of frequency bands; and
generating at least one broadband decorrelated audio signal, wherein the at least one broadband decorrelated audio signal is usable to upmix the downmixed audio signal, and wherein ducking gains of the set of ducking gains are applied to at least one of: 1) a second set of frequency bands prior to generating the at least one broadband decorrelated audio signal; or 2) a third set of frequency bands that separates the at least one broadband decorrelated audio signal.

2. The method of claim 1, wherein the set of ducking gains comprises a set of input ducking gains, and further comprising applying input ducking gains of the set of input ducking gains to the second set of frequency bands prior to generating the at least one broadband decorrelated audio signal.

3. The method of claim 2, wherein ducked signals associated with frequency bands of the second set of frequency bands are aggregated to generate a broadband ducked signal that is provided to a decorrelator configured to generate the at least one broadband decorrelated audio signal.

4. The method of claim 1, wherein:
the first set of frequency bands and the second set of frequency bands are two instances of the same set of frequency bands; or
the first set of frequency bands is the same as the third set of frequency bands; or
the first set of frequency bands, the second set of frequency bands, and/or the third set of frequency bands comprise three frequency bands.

5. The method of claim 1, wherein the set of ducking gains comprises a set of output ducking gains, and further comprising:
applying output ducking gains of the set of output ducking gains to the third set of frequency bands to generate at least one set of ducked decorrelated audio signals, each ducked decorrelated audio signal in the at least one set of ducked decorrelated audio signals corresponding to a frequency band of the third set of frequency bands; and
aggregating ducked decorrelated audio signals in the at least one set of ducked decorrelated audio signals to generate at least one broadband ducked decorrelated audio signal, the at least one broadband ducked decorrelated audio signal being usable to upmix the downmixed audio signal.

6. The method of claim 1, wherein determining the set of ducking gains comprises:
determining one or more initial ducking gains; and
modifying at least one of the one or more initial ducking gains to generate the set of ducking gains, wherein the at least one of the one or more initial ducking gains are modified by performing update and/or release control.

7. The method of claim 1, wherein, for a frequency band of the first set of frequency bands, a corresponding ducking gain is determined based on a ratio comprising outputs of two envelope trackers, the two envelope trackers corresponding to a slow envelope tracker and a fast envelope tracker.

8. The method of claim 7, wherein the slow envelope tracker comprises an absolute value computation block and a first low pass filter, and wherein the fast envelope tracker comprises the absolute value computation block and a second low pass filter, the first low pass filter and the second low pass filter having different time constants.

9. The method of claim 7, further comprising applying a high-pass filter to at least one frequency band of the first set of frequency bands, wherein an output of the high-pass filter is provided to at least one of the two envelope trackers.

10. The method of claim 9, wherein the high-pass filter is applied to two or more frequency bands of the first set of frequency bands, and wherein the high-pass filter applied to a first of the two or more frequency bands has a different cut-off frequency than the high-pass filter applied to a second of the two or more frequency bands.

11. The method of claim 7, wherein a first low-pass filter of the slow envelope tracker has a time constant longer than a time constant of a second low-pass filter of the fast envelope tracker, and wherein the ratio comprises an output of the slow envelope tracker to an output of the fast envelope tracker.

12. The method of claim 7, wherein a first low-pass filter of the slow envelope tracker has a time constant longer than a time constant of a second low-pass filter of the fast envelope tracker, and wherein the ratio comprises an output of the fast envelope tracker to the slow envelope tracker.

13. The method of claim 7, wherein the ratio comprises a constant specific to the frequency band of the first set of frequency bands, the constant selected to control at least one of: 1) an amount of ducking gain applied to each frequency band of the second set of frequency bands; or 2) an amount of ducking gain applied to each frequency band of the third set of frequency bands.

14. The method of claim 1, wherein separating the input audio signal into the first set of frequency bands comprises providing the input audio signal to a filterbank.

15. The method of claim 14, wherein the filterbank is implemented as an infinite impulse response (IIR) filterbank or a finite impulse response (FIR) filterbank.

16. (canceled)

17. (canceled)

18. The method of claim 1, wherein the at least one broadband decorrelated signal comprises two or more broadband decorrelated signals.

19. The method of claim 1, further comprising upmixing the downmixed audio signal using the at least one broadband decorrelated signal and metadata received at the decoder to generate a reconstructed audio signal.

20. The method of claim 19, further comprising rendering the reconstructed audio signal to generate a rendered audio signal, and optionally presenting the rendered audio signal using one or more of: a loudspeaker or headphones.

21. (canceled)

22. An apparatus configured for implementing the method of claim 1.

23. One or more non-transitory media having software stored thereon, the software including instructions for controlling one or more devices to perform the method of claim 1.
